(19) United States
(12) Patent Application Publication
(10) Pub. No.: US 2010/0237303 A1
(43) Pub. Date: Sep. 23, 2010

(54) Door jockey

(76) Inventor: Thomas Christopher Flynn, Hopkins, MN (US)

Correspondence Address: Thomas Flynn, 217 18th Ave. N., Hopkins, MN, 55343, US

(21) Appl. No.: 12/381,906

(22) Filed: Mar. 18, 2009

(51) Int. Cl. B62B 3/06

(52) U.S. Cl. 254/2 R

(57) ABSTRACT

The substance of this invention pertains to the subject of installing pedestrian entrance and exit doors in the construction industry. What's new about this invention is how doors can now be installed. The primary newness is the way that the vertical and horizontal adjustment is achieved, during the installation.

### CROSS REFERENCE TO RELATED APPLICATIONS

“Not Applicable”

### STATEMENT REGARDING SPONSORED RESEARCH OR DEVELOPMENT

“Not Applicable”

### REFERENCE SEQUENCE LISTING, A TABLE, OR A COMPUTER PROGRAM LISTING COMPACT DISC APPENDIX

“Not Applicable”

### BACKGROUND OF THE INVENTION

Relates To: The construction industry. The process of installing pedestrian entrance and exit doors. New tool (machine) for installing such doors. The purpose for such invention is to make the process easier, safer, and more economical for the installer. The existing process involves the installer trying to awkwardly try to balance a typical pedestrian door (3′-0″×7′-0″, 80-100 lbs.) with one hand while trying to fasten the door to the frame opening with the other hand. This is usually accomplished by using a cordless drill, or some other fastening device. The other obstacle facing the installer, is how to hold the door to the proper elevation at the same time. As the door is shorter than the framed opening, the door needs to be raised for the hinges to line up with the butt cut-outs in the frame.

### BRIEF SUMMARY OF THE INVENTION

The main purpose for this invention is to increase the productivity for installing pedestrian entrance and exit doors. The idea is to make it safer, and more economic for one person to do the installation. Where before the awkwardness of trying to balance and hold a door to the proper elevation, with one hand, and try to fasten the door to the door frame with the other hand, this is now eliminated. With The Door Jockey, the door is now held securely upright in place, and any adjustment of the door vertically or horizontally is controlled by the unit. The installer's hands are now free to fasten the door to the door frame.

### BRIEF DESCRIPTION OF THE SEVERAL VIEWS OF THE DRAWING

This section includes (7) different views of the drawing. The views are listed as “FIG. 1”-“FIG. 7”

FIG. 1: Three dimensional view

FIG. 2: Front side longitudinal view

FIG. 3: Right side end view

FIG. 4: Plan view (middle section)

FIG. 5: Inside longitudinal view looking toward rear

FIG. 6: Plan view (complete)

FIG. 7: Left side end view

### DETAILED DESCRIPTION OF THE INVENTION

(A) The physical properties of this invention are as follows:
   1) Material make-up: Grade A36 mild steel,
   2) Dimensions: 24″L×9¼″W×12″H

### 3) Weight: 31 lbs.

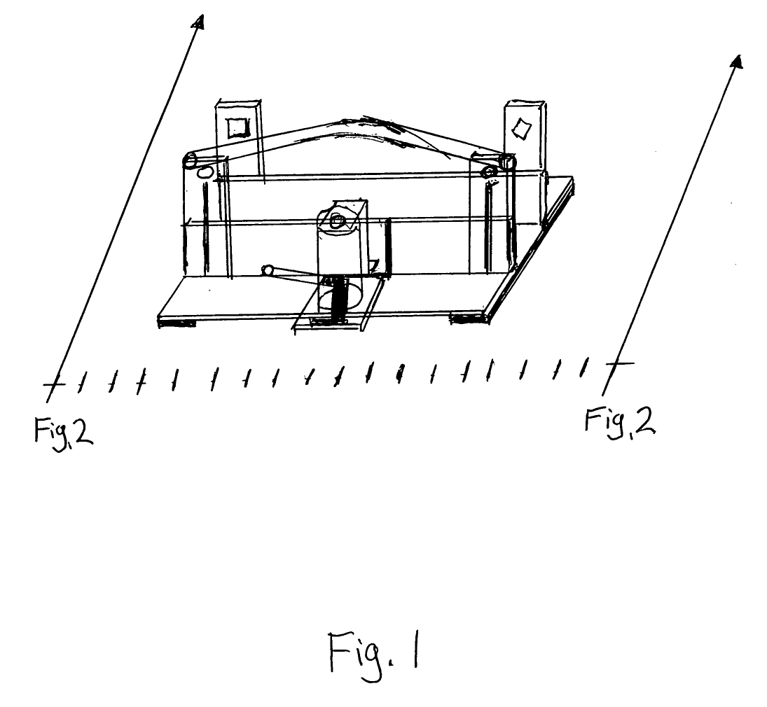

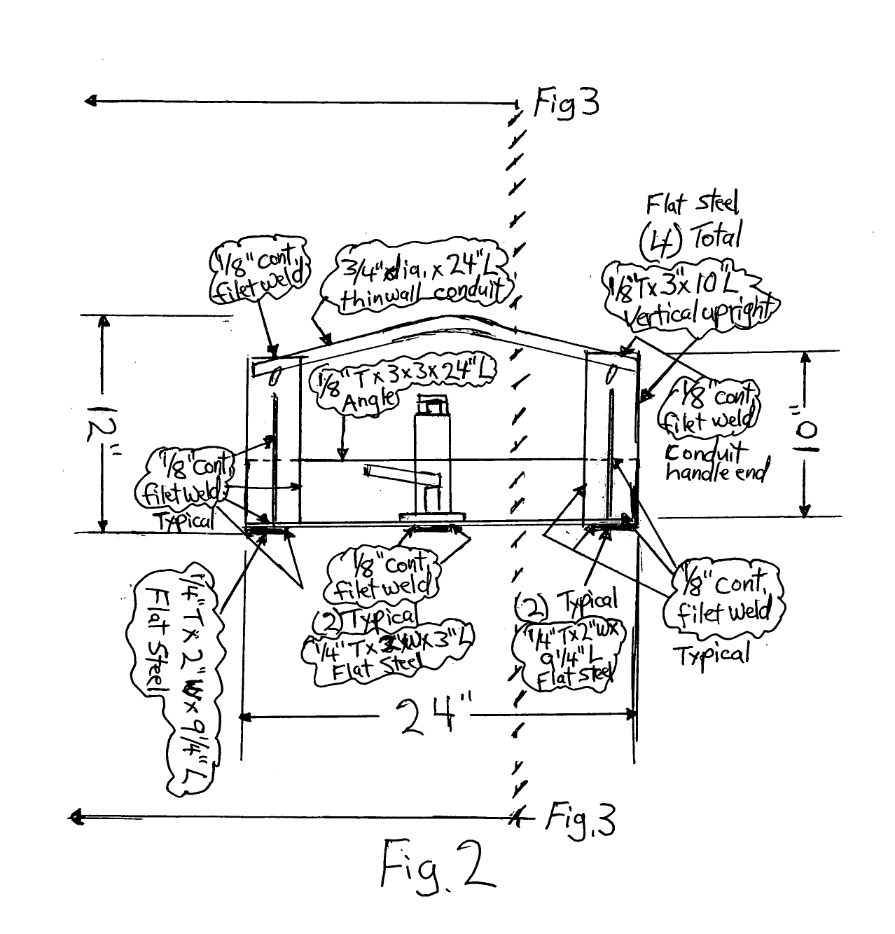

4) Vertical adjustment range: ½″-3″
5) Weight lifting capacity: 110 lbs.
(B) The following is a step by step direction on how to manufacture “The Door Jockey” A reference to
a list of drawings (FIG. 1-7) will be used to help this process. If FIG. 2 is used for example, I will be using the drawing of the right side end view to help explain a step in the process. EG. See FIG. 2. From now on, if the word “Invention” is used, I will be referring to The Door Jockey.

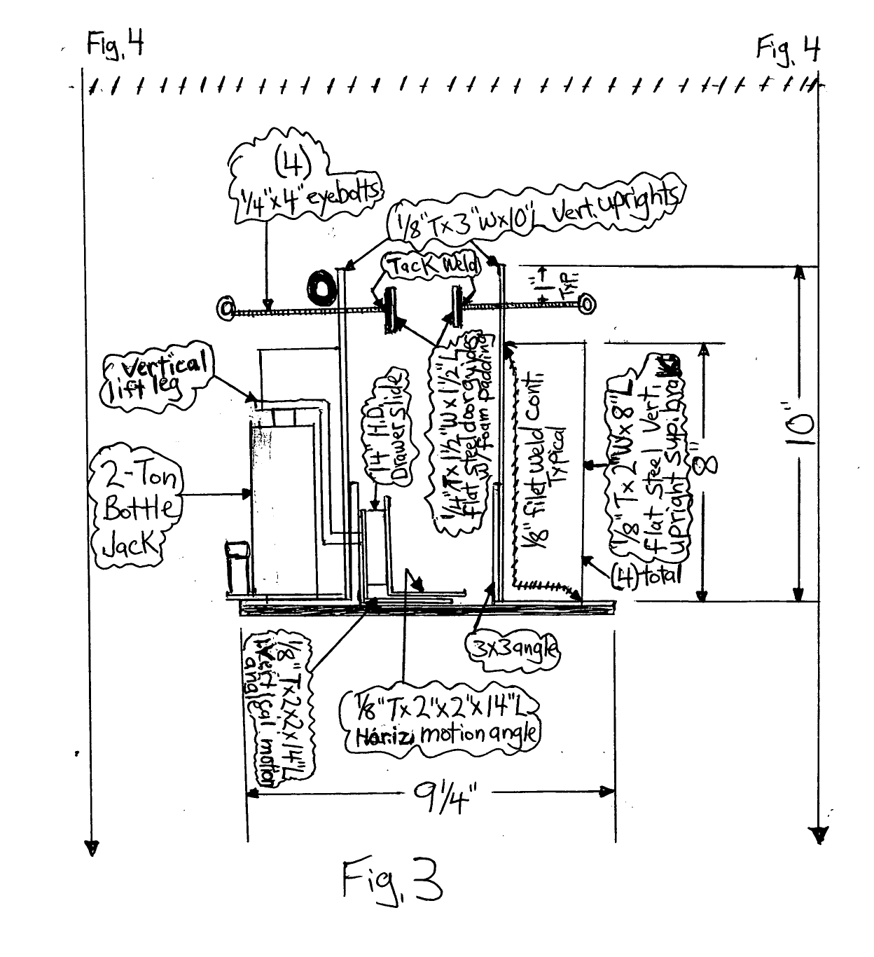

Building The Invention: Assembling The Main Frame
Step 1) Start with (2) pieces of ⅛″thick×3″ equal leg angle steel 24″ long. Note: If you can't find ⅛″T×3″ equal leg angle, you will have to use (2) pieces of ⅛″T×3″W×24″L flat steel and weld two of the edges together, forming a 90 degree angle. Use a ⅛″ filet weld for 1″, in every 3″ along the 24″ edge.
Step 2) Weld (1) vertical upright ⅛″T×3″W×10″L flat stock steel to each end of 24″L equal leg angle. (4) uprights total. (See FIGS. 1 and 2)
Step 3) Connect both 3″×3″×24″L angles together by welding (1) ¼″T″2″W×9¼″L flat stock steel, perpendicular to each end bottom. Also, weld (1) piece ¼″T×2″W×3″L flat stock steel, perpendicular to the middle of each 3″×3″×24″L angle bottom. (See FIGS. 2,3, and 6)
Step 4) Weld (1) support leg ⅛″T×2″W×8″L flat stock steel to back of each vertical upright. (4) pieces total. (See FIGS. 2 and 3).

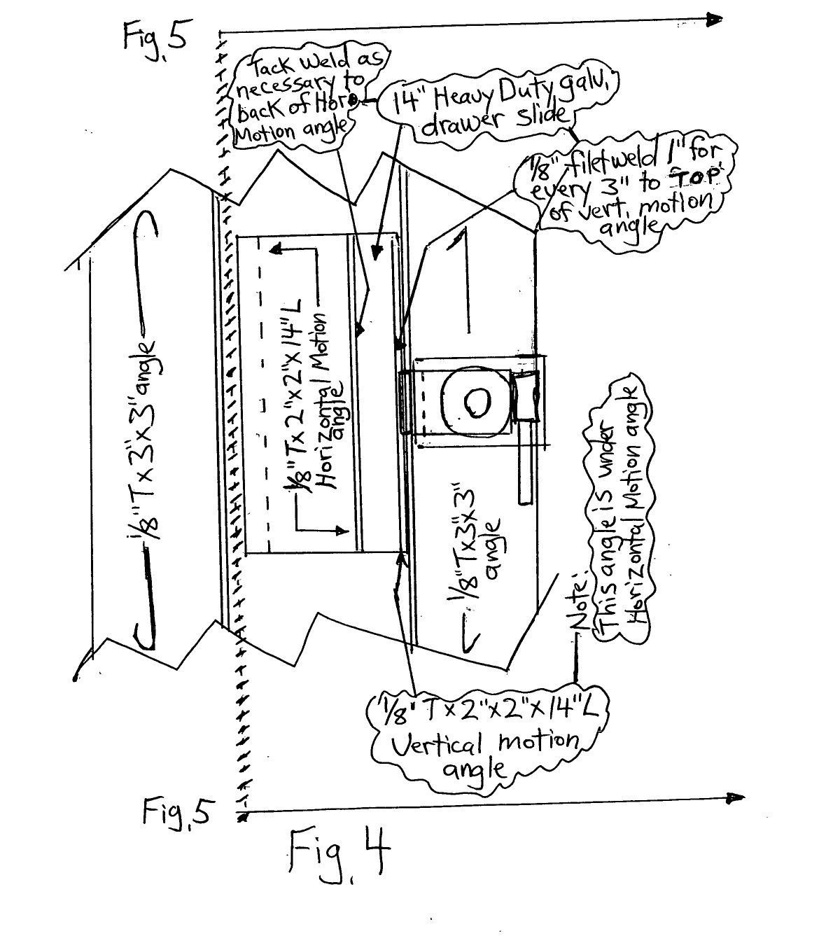

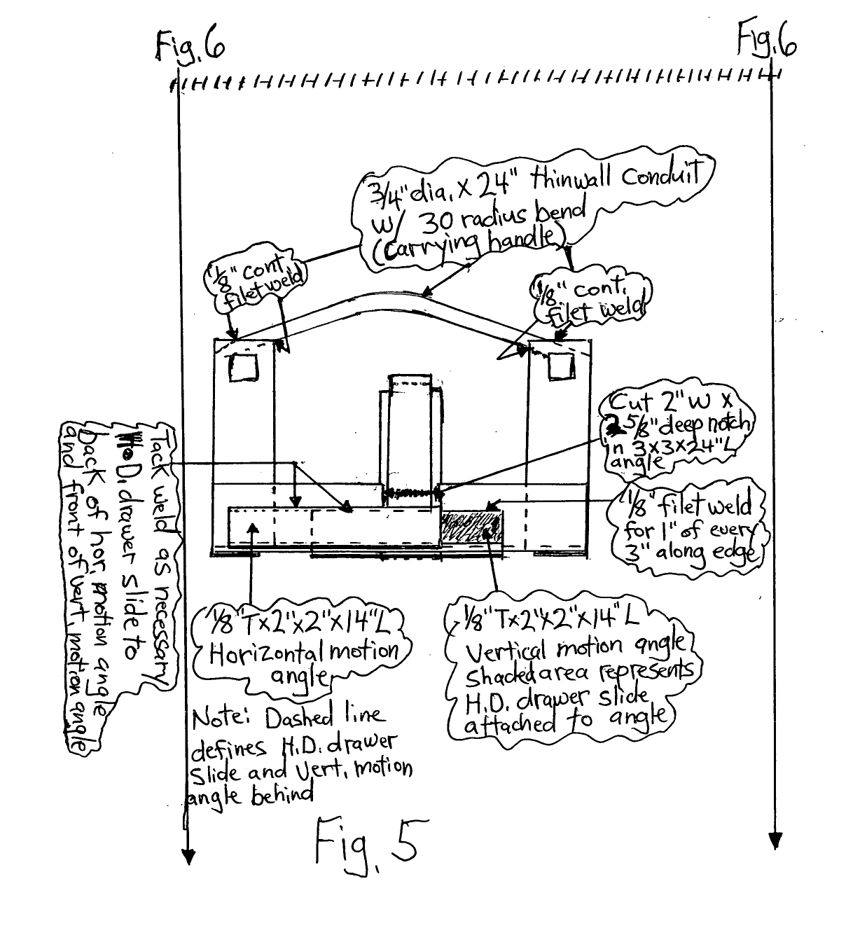

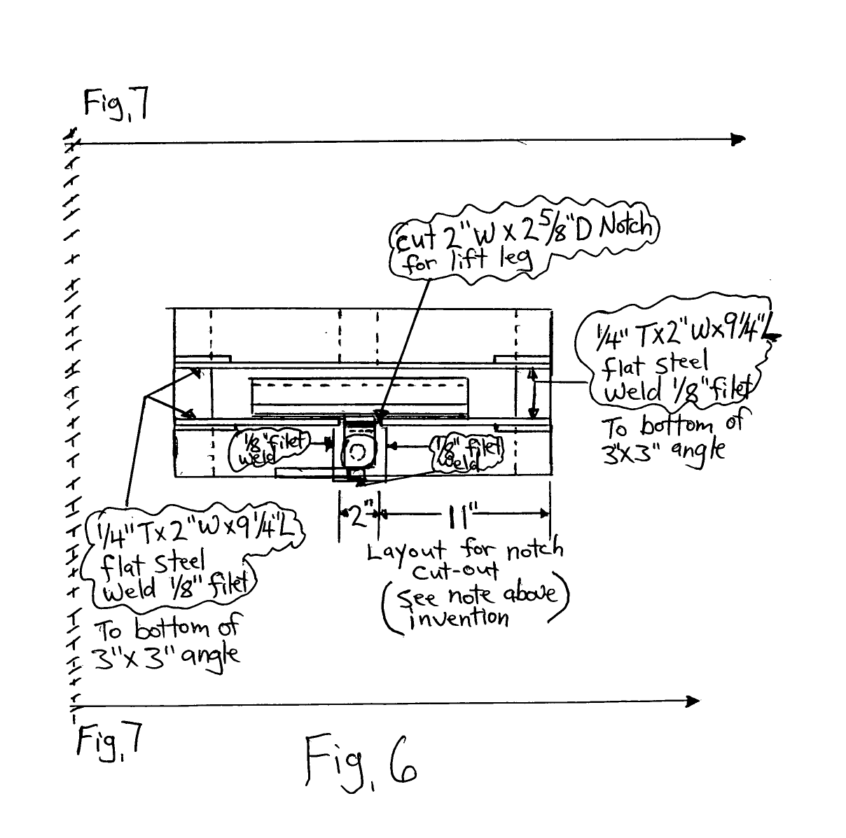

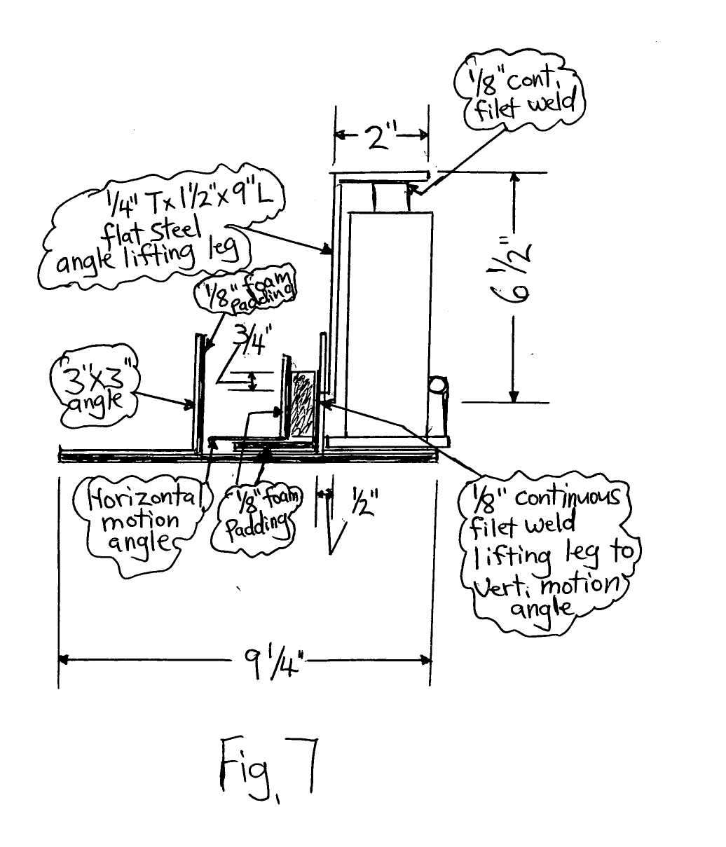

Assembling the Moveable Components of the Invention:
Step 5) Cut 2″ wide×2⅝″ deep notch in the center of the vertical leg of the front 3″×3″×24″L angle to allow movement of the vertical lift leg. (See FIGS. 3,6, and 7)
Step 6) Weld base of 2-ton hydraulic bottle jack to the center of the horizontal leg of the front 3″×3″×24″L front angle. Should be centered with notch in vertical leg of same angle. Hold bottle jack as close to vertical leg as possible. (See FIGS. 3,6, and 7)
Step 7) Take (1) piece ¼″T×1½″W×9″L (Vertical lift leg), and heat and bend into three segments, with 90 degree angles between them. The first segment should be ½″. The second segment should be 6½″. The third segment should be 2″. I used an acetylene/oxygen torch and a bench vice to accomplish this. (See FIGS. 3 and 7).
Step 8) Weld vertical lift leg (from step 7) to vertical motion angle ⅛″T×2″×2″×14″L. Vertical lift leg should be centered horizontally on 2″×2″, and also through notch of 3″×3″ angle from step 5. (See FIGS. 6 and 7).
Step 9) Weld 2″ segment of vertical lift leg to top of bottle jack. (See FIGS. 3 and 7).
Step 10) Glue ⅛″T×2″W×14″L strip of ethefoam padding onto top horizontal leg of the vertical motion angle. This provides separation and friction reduction between the vertical and horizontal motion 2″×2″×14″L angles. (See FIG. 7).
Step 11) Weld 14″ heavy duty galvanized drawer slide to the front of the vertical leg of the vertical motion angle. Main body of the drawer slide should be welded here. (See FIGS. 3, 4, and 5).
Step 12) Weld 14″ heavy duty galvanized drawer slide from step 11 to the back of the vertical leg of the horizontal motion angle. Inside nested smaller portion should be welded here. (See FIGS. 4 and 5). Make sure there is fluid movement of the drawer slide and horizontal movement angle after the welding process is completed. If not some grinding may be necessary to remove any excess slag build-up that may have occurred during welding.
Step 13) Drill and tap (1) ¼-20 hole at top of each ⅛″T×3″W×10″L vertical upright. Hole should be 1″ down from the top and 1½″ in from either edge (or centered). Thread ¼-20×4″ long eyebolt through each hole. Tack weld as necessary a piece of flat stock steel ¼″T×1½″×1½″ to threaded end of each bolt. (See FIG. 3)
Step 14) Weld carrying handle (¾″×24″ long thin wall conduit) to back of vertical uprights of front of invention. (See FIG. 2)
Step 15) Grind all sharp edges and rough welds of metal as necessary. Cover all vertical surfaces to be in contact with door finishes with ⅛″ ethefoam padding. (See FIGS. 3 and 7).
Step 16) Paint invention using Royal Blue color interior/exterior premium enamel spray paint.

Use of the Invention:
1) The invention should sit flat on the floor, perpendicular to the door frame, with the right side lined up directly adjacent to the hinge side of the door frame. (Approx. 9″ from the door frame) Make sure that the front of the invention is always facing toward your right, and that you are on the hinge butt cut-out side of the door frame.
2) Stand your door upright inside the invention, with the hinges facing the door jamb. (Assuming that the hinges are already mounted on the door). Make sure the door is somewhat centered within the frame of the invention. The hinge side edge of the door should be approx. 3″ from the door frame. The bottom of the door should be resting firmly on the horizontal motion angle. (The top 2″×2″×14″ angle). Adjust the door guides by turning the ¼-20×4″long eyebolts in or out as necessary to keep the door plumb, aligned with the door jamb.
3) Slide door forward as needed up to the door jamb. Check alignment of hinges on door with hinge butt cut-outs on door frame. If door needs to be raised, use the vertical adjustment by pumping the handle of the bottle jack up and down until desired elevation is reached. Once the top hinge is attached to the door frame, lower the jack a bit, to take pressure off of the door, until the lower hinges are positioned where they need to be.
4) Once all of the hinges are fastened, lower the jack the rest of the way, and slide the invention out from under the door.

1. This invention, I believe to be the first of it's kind. The main frame is stationary. It's sturdy, yet light enough to carry around. The vertical and horizontal movement does not rely on rolling caster wheels. Although the general idea of using some sort of mechanical device to assist in hanging doors is not new, the very unique nature of this invention is.
